(19) United States
(12) Patent Application Publication
(10) Pub. No.: US 2004/0235458 A1
(43) Pub. Date: Nov. 25, 2004

(54) Automatic activatation of a wireless device

(76) Inventors: Charles Lee Walden, Richmond Hill, GA (US); Daryl Wiley, Savannah, GA (US); Chris Hunt, Savannah, GA (US)

Correspondence Address: KENYON & KENYON, 1500 K STREET, N.W., SUITE 700, WASHINGTON, DC, 20005, US

(21) Appl. No.: 10/443,859

(22) Filed: May 23, 2003

(51) Int. Cl. H04Q 7/20

(52) U.S. Cl. 455/414.1

(57) ABSTRACT

A system and method for activating a wireless services account while requiring only numeric data from a user, such as a social security number, date of birth and/or telephone number. The numeric data, which can be provided by the user through a telephone keypad, can be used to obtain additional information about the user through demographic and credit databases. A business rule and information about the user can be utilized to determine a characteristic of a wireless service plan for the user. A wireless service account can thus be established while requiring only numeric data from the user.

### FIELD OF THE INVENTION

The field of the invention is wireless communication, and in particular activating a wireless service for a user in such a way that only numeric input about the user is required from the user.

### BACKGROUND OF THE INVENTION

The user of a wireless communications device often must establish a billing relationship with a wireless service provider to use the device. Establishing this relationship requires that the user interact with one or more human representatives of the service provider and provide spoken and/or written information such as the name of the user; the user's billing address; a valid financial instrument of the user, such as a credit card, a debit account, a prepaid account, etc. Extensive spoken and/or written input from the user can also be required for selecting a service profile (e.g., rate plan, service features, etc.) for the account.

Spoken and written information is often provided by the user at a retail store or kiosk that sells a cell phone to a user. A wireless services salesman (a wireless services sales representative) must acquire the necessary demographic information from the user; submit at least some of it to a credit bureau, receive a credit score for the user from the credit bureau; and then implement business rules to select the appropriate rate plan options from possibly hundreds or even thousands of possible rate plans and service features, and present them to the user. When a rate plan and service features are selected by the user, the salesman can establish the wireless service account. This process can require costly and extensive training for the salesman. Due to its complexity, the process can be fraught with errors. The user's handwriting can be unclear, or one or more of his spoken responses may be misunderstood. There is no guarantee that the salesman will properly gather all of the necessary information, or implement the business rules correctly.

This type of human interaction can also be provided through the use of customer care call centers, at which several human operators accept calls from users who wish to establish a billing relationship and set up a service profile for using wireless services. A human operator typically follows a predetermined script, asking the user to provide demographic information for validating the user and establishing a relationship with the wireless service provider. The user responds orally to these questions, and the human operator enters the information gathered from the user manually into a computer system. The operator follows procedures similar to those of the salesman at a retail store or kiosk. The customer care representative must be trained, which can be expensive, and paid to collect user information and help the user select a rate plan. The care center can be operated by the service provider, or by a company that charges the service provider a commission for each user that is activated. In either case, a customer care center is expensive to operate, and can be prone to error. The operator may misunderstand some of the responses spoken by the user to operator queries.

### SUMMARY OF THE INVENTION

In accordance with an embodiment of the present invention, a system and method can advantageously activate wireless service for a user while requiring only numeric input from the user. The need for complex and extensive alphanumeric and other non-numeric input is thus advantageously avoided. As used herein, the term “from the user” is meant to encompass both from the user directly and indirectly. In other words, the numeric information about the user can be entered directly by the user, e.g., in to a keypad by the user on the user's regular or cellular telephone. Alternatively, the numeric information about the user can be entered by an intermediary, such as a wireless services sales representative (either in person or as a call center operator) after gathering from the user or from a database. As used herein, numeric information includes the integers 0-9. An embodiment of the present invention can accept other characters that may be used as delimiters for numeric information. For example, an embodiment can ask the user to enter numeric information (e.g., the user's social security number, street address number, etc.) followed by a “pound sign” (“#”) to indicate a boundary (e.g., the end) of the user's entry. Examples of numeric entries can include “123456789”, “123-45-6789”, “4563#”, “123#4567#”, etc.

An embodiment of the present invention can use this numeric information to validate the user; obtain additional information about the user from demographic and credit bureau databases; implement business rules to select one or more rate plans with service features, along with other characteristics of the wireless services to be provided to the user; and collect from the user payment information that can be forwarded to a billing system. A characteristic of a wireless service is any aspect of the service, such as one or more service features, rate plans, conditions under which a wireless service is to be activated (e.g., as embodied in a business rule); bandwidth; etc. Thus, determining a characteristic of a wireless service plan for a user can include one or more of selecting a rate plan for a user; selecting a set of rate plans that are available to a user; selecting one or more service features for a user; setting one of more conditions under which a wireless service can be activated for a user; etc. The user can input numeric information by pressing the keys on a keypad of a cellular telephone or other wireless device. Further, any suitable means can be used by the user for inputting his numerical information, such as a graphical keypad on a Personal Digital Assistant, the numeric keys on a computer keyboard, etc.

The numeric-only information can be provided to an embodiment of the present invention by, for example, an automated query system (e.g., an Automated Voice Response (AVR), a visual menu, etc.) that can prompt a user to enter numeric information. Alternatively, a salesman can ask a user for numeric information, and then provide the user's numeric information to a system in accordance with an embodiment of the present invention. In either case, the system can automatically validate the user; obtain additional information about the user from demographic and credit databases; implement business rules; suggest one or more rate plans; and accept and validate billing information; etc.; all while requiring only numeric input from the user. But an advantage of the present invention is to allow a user to activate or change a characteristic of a wireless service account using a very simple input device, such as the keypad on a regular or cell phone. This advantageously reduces the amount of information that is often required from users by known systems to activate a wireless service account, and streamlines the process for doing so.

### BRIEF DESCRIPTION OF THE DRAWINGS

FIG. 1 is a flow chart showing the method in accordance with an embodiment of the present invention.

FIG. 2 is a diagram showing a system in accordance with an embodiment of the present invention.

FIG. 3 is a diagram showing an apparatus in accordance with an embodiment of the present invention.

### DETAILED DESCRIPTION

In accordance with an embodiment of the invention, a user of a wireless device can call a toll-free number using the device, or otherwise connect to an activation server at little or no cost to the user. Examples of a wireless device include a cell phone, a Personal Digital Assistant such as the Palm i705 manufactured by Palm, Inc.; etc. The user will be connected to the server, which can include a processor coupled to a memory. The processor can be a general purpose microprocessor, such as the Intel Pentium IV processor, manufactured by the Intel Corporation of Santa Clara, Calif. The processor can be an Application Specific Integrated Circuit (ASIC) that embodies at least part of the method in accordance with the present invention in hardware and/or firmware. The memory can be any device that can store digital information, such as Random Access Memory (RAM), a hard disk, flash memory, etc.

Rather than connecting to the activation server by the user calling a number, numeric information from the user can be collected by a salesman and entered into an electronic (e.g., computer) terminal, which sends it to the activation server. Whether entered by the user or the salesman, the activation server can advantageously automatically, quickly, accurately and at lower cost perform many of the functions performed by the salesman (or call center operator) in certain known systems.

The device utilized to input the user's numeric information can include a telephone (cellular, cordless or wired) keypad; a computer keyboard; a graphic display; a voice recognition interface; a handwriting recognition interface of the kind found on Personal Digital Assistants such as those made by the Palm, Inc.; etc. The device can have non-numeric keys or other mechanisms for entering data, but the user is required only to enter numeric information in accordance with the present invention. For example, a cell telephone keypad has ten keys numbered from 0 to 9. Most of the keys have three letters associated with them. For example, the “2” key is associated with the letters A, B and C. Likewise, a computer keyboard has many alphabetic keys, in addition to numeric keys. The numeric keys on these input devices are the only ones that need be used to constitute the information required from the user, e.g., the user's social security number; the user's date of birth; the user's credit card number; etc.

Of course, other keys can be used to enter information other than information about the user. For example, in some systems, a user must press the pound key (“#”) to indicate that the requested numeric data has been fully entered, and to proceed to the next step (e.g., “Enter your social security number, followed by the pound sign.”) Likewise, the user may press the star key (“*”) to navigate and select among different menus and options. Thus, the present invention can require the user to input non-numerical information for purposes other than supplying information about the user itself, e.g., to move about the menus, to select an option, to indicate the end of a piece of information about the user. But all of the information about the user (demographic information about the user) can be entered as numerical data. As used herein, “demographic” information includes any information about a person or persons, such as a social security number, a date of birth, a location of birth, a residence address, an account number, a work address, credit information, marital status, etc. This information can be entered by the user himself, or by an agent of the user, such as a salesman or call center operator.

The memory can store wireless activation instructions (collectively, a service application) that are adapted to be executed by the processor to perform the method in accordance with an embodiment of the present invention. The memory can also store wireless activation data. For example, the memory can store activation data that represents a prerecorded or machine generated voice that the wireless service application can cause to pose questions to the user over the toll free connection in accordance with the activation instructions.

In one embodiment, the user is asked to enter its social security number using the numeric keypad on its cell phone. The user can also be asked to enter it's date of birth, telephone number, etc.

The numeric data entered by the user is carried through the network to the activation server, where the activation application uses the data to obtain other information about the user that, in some known systems, is gathered laboriously by a human operator (e.g., a salesman, a customer care operator, etc.) This can be done by the activation application by using the data entered by the user as one or more keys for searching one or more databases (e.g., demographic databases, credit bureau databases, etc.) for the additional information. This additional information can be numeric, alphanumeric, or of any other suitable form.

For example, the user's social security number can be used to formulate one or more queries to one or more demographic databases that store records that correlate the social security number to the person's name, address (e.g., e-mail address, residential address, business address, etc.), driver's license number, age, gender, etc. The information that results from such searches can then be used as the basis of further queries, e.g., to ask the user to confirm another fact about the user; to query one or more credit bureaus. The credit bureau query can return a credit score and other, more detailed credit and/or demographic information about the user.

The information obtained about the user based upon these queries can be used to authenticate and validate the user. For example, a user can supply only its social security number to the activation application. The activation application can use the social security number to fetch other information about the user, and then issue queries to the user to authenticate the user's identity, i.e., to verify that the user is indeed who the user claims to be. For example, the activation application can ask the user to supply it's social security number; use the social security number to query one or more demographic databases and obtain the user's home address and the length of time the user has lived at that address; and ask the user to enter numeric information to verify that address, e.g., to enter the user's residence number, the user's zip code, etc., and the length of time in years that the user has lived at its current residence. If the user's answers are incorrect, i.e., do not match the information retrieved from the demographic databases, then the user is not validated; if they match, the user can be validated. This can advantageously preclude a person with a stolen social security number from masquerading as someone else, and enjoying wireless services at the expense of the person from whom the social security number was stolen.

After a user has been validated, an embodiment of the present invention can apply one or more business rules to determine if the user should be approved to become a customer of the service. For example, a user must have a minimum credit score and its identity must be confirmed by correct responses to at least two authentication queries from a predetermined list of authentication queries to be approved to become a customer. The predetermined list of authentication queries can include correctly providing the number of years the user has been at its current residence; correctly providing the user's mother's maiden name; correctly providing the user's current residential address; etc. The credit score can be obtained by the activation application sending a query to a credit bureau database and receiving a credit score in response.

One or more business rules can be implemented based upon any suitable inputs of information and/or upon meeting any suitable condition. For example, a business rule can select a rate plan based upon the marital status of the prospective customer; occupation; address or other indication of geographical location; credit score; past calling behavior; past purchasing behavior; interests; the location of family members and/or friends whom the user is likely to call; birthplace (e.g., domestic or foreign); and any suitable combination of such factors; etc. A business rule can be as simple or sophisticated as desired. For example, business rules can be implemented selectively as a part of a decision tree, e.g., a second business rule can be selected from a plurality of possible second business rules for implementation based upon the outcome of the application of a first business rule. Several business rules, each of which can require at least partly different inputs, can be implemented in a predetermined order.

The activation application can advantageously establish a service profile for the user's wireless account based on input from the user that is exclusively numerical. For example, a digitally stored voice can present various rate plan and service options to the user, and the user can be asked to make the appropriate selections. The voice can, for example, ask the user to press “1” for a basic rate plan, the properties of which the voice can describe (e.g., 100 minutes of service during prime time and 200 minutes of service during off-peak hours per month for a $25 monthly fee); press “2” to select a premium rate plan (e.g., 500 minutes of service per month at any time for a $50 monthly fee); and “3” to select additional premium services. Selecting “3” can lead to another menu, which asks the user to provide numeric input to select options at given prices for additional services, such as an e-mail account; a voicemail account; service guarantees; etc. In this way, the user can advantageously select and build its own rate plan and service features simply by entering numeric information and without having to interact with a human being.

An embodiment of the present invention can also collect payment information from the user. For example, the system can automatically collect credit card information, debit card information, prepaid account information, etc. This can be passed on to a billing system to effectuate payment from the user for wireless services, and can be accomplished using only numerical information that is received from the user.

The information collected and verified by an embodiment of the present invention can advantageously be used by a wireless network provider to provision the user's account with the selected service profile.

In accordance with an embodiment of the present invention, information from a user about a user can be used to activate a wireless service account. While certain known systems require extensive oral and/or alphanumeric information from the user to activate an account, an embodiment of the present invention advantageously activates a wireless service account in a way that requires the user to provide only numeric information, and typically a small amount of only numeric information. This is advantageously more efficient and easier than certain known systems.

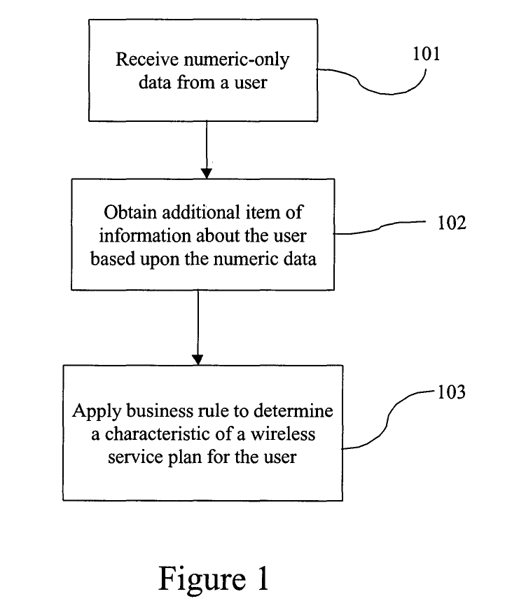

The method in accordance with an embodiment of the present invention is shown in FIG. 1. Numeric-only data is received from a user, step 101. This numeric-only data is used to obtain additional information about the user, step 102. Information about the user is used in conjunction with a business rule to determine at least one characteristic of a wireless service plan for the user, step 103.

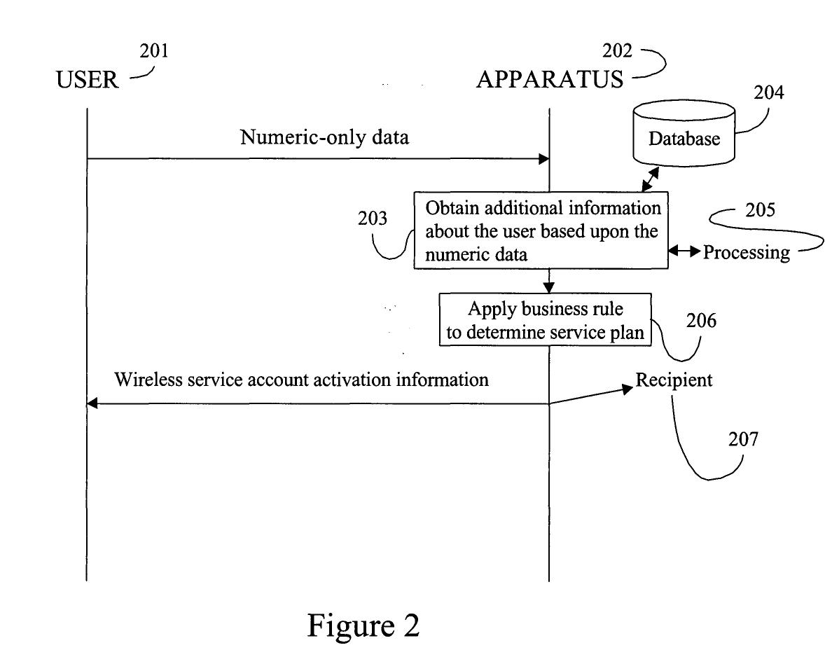

An system in accordance with an embodiment of the present invention is shown in FIG. 2. User 201 interacts with apparatus 202 to activate a wireless service account. The activation requires only numeric data from the user. Apparatus 202 obtains additional information about the user 201 based upon the numeric data (function 203) by consulting a database 204 and/or by internally processing the numeric data. For example, certain numeric data that can be provided by the user, such as a zip code, can be internally processed by apparatus 202 to obtain further information, e.g., a geographic area associated with the user zip code. Likewise, certain numeric data from the user 201 can be used directly with a business rule (alone, in combination with other such numeric data, or in combination with additional information obtained about the user) to determine a characteristic of a wireless service plan (function 206) for user 201. Wireless service account information can be passed to user 201 and/or to a third party recipient 207.

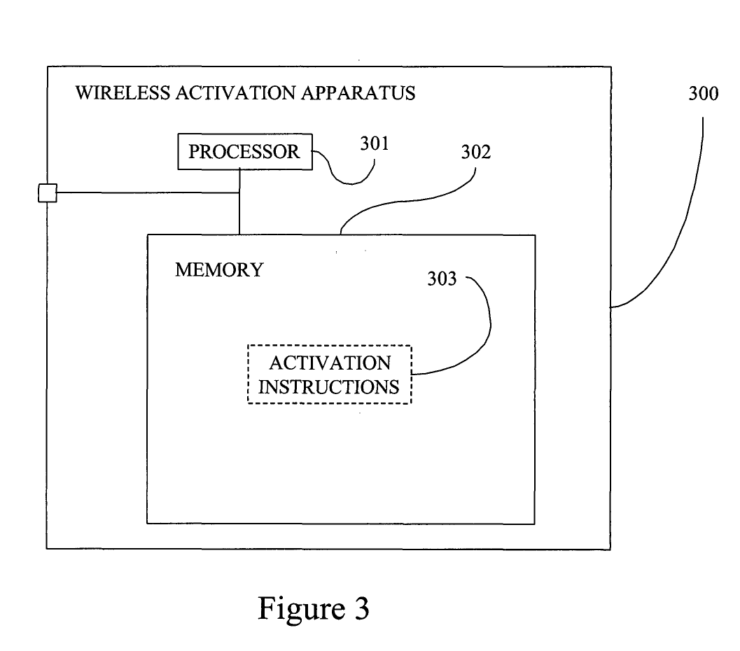

An apparatus in accordance with an embodiment of the present invention is shown in FIG. 3. Wireless activation apparatus 300 includes processor 301 coupled to memory 302. Memory 302 stores wireless activation instructions (software) adapted to be executed by processor 301 to receive data that is provided by the user in numeric-only form; obtain an additional item of information about the user based upon the numeric data; and apply a business rule to determine a characteristic of a wireless service plan for the user. The business rule can be based upon information about the user.

The foregoing description is meant to illustrate, and not to limit, the true scope of the present invention. Those of skill in the art will appreciate that the present invention encompasses further embodiments that may not be described herein, but nevertheless are covered by the claims.

What is claimed is:

1. A method for activating a wireless service for a user, including
receiving from the user data about the user that is only numeric;
obtaining an additional item of information about the user based upon the numeric data;
applying a business rule to determine at least one characteristic of a wireless service plan for the user, using information about the user.

2. The method of claim 1, wherein the numeric user data is input using a numeric keypad.

3. The method of claim 1, wherein the numeric user data from is input by a wireless services sales representative using a keypad.

4. The method of claim 1, wherein the numeric data about the user is the social security number of the user.

5. The method of claim 1, wherein the numeric data about the user is a telephone number of the user.

6. The method of claim 1, wherein the numeric data about the user is the date of birth of the user.

7. The method of claim 1, wherein the numeric data about the user is the house number in the address of the user.

8. The method of claim 1, wherein the numeric data about the user is the user's zip code.

9. The method of claim 1, wherein the additional item of information is obtained by formulating a query based on the numeric data about the user, sending the query to a demographic database, and receiving a response from the demographic database.

10. The method of claim 1, wherein the additional item of information is obtained by formulating a query based on the numeric data about the user, sending a query to a credit bureau database, and receiving in response a credit score for the user.

11. The method of claim 1, wherein further including:
sending to the user a query to confirm the additional item of information;
if the user correctly confirms the additional item of information, then the user is validated; and
if the user does not correctly confirm the additional item of information, then the user is not validated.

12. The method of claim 9, wherein the response received from the demographic database includes an address of the user.

13. The method of claim 10, wherein the business rule requires that the user have a minimum credit score to activate a wireless service account for the user.

14. The method of claim 1, wherein the business rule determines the service plan based upon the user's zip code.

15. The method of claim 1, wherein the business rule determines the service plan based upon the occupation of the user.

16. The method of claim 10, wherein the business rule selects at least one rate plan based upon the credit score of the user.

17. The method of claim 1, further including applying a business rule to determine if the user should be approved for a wireless service account, wherein the business rule includes a requirement that the user is validated by correctly answering at least a predetermined number of requests for demographic information, wherein an answer is correct if it is consistent with demographic information obtained about the user from at least one demographic database.

18. The method of claim 1, further including sending wireless service account activation information for the user to a recipient, which causes the recipient to activate a wireless service account for the user.

19. The method of claim 1, further including receiving from the user a service profile selection.

20. The method of claim 1, further including receiving from the user a rate plan selection.

21. Activating a wireless service account for a user wherein the only information required to be provided by the user to activate the account is numeric information.

22. An apparatus for activating a wireless service for a user, including
a processor;
a memory coupled to said processor, said memory storing activation instructions adapted to be executed by said processor to receive data about the user that is only numeric; obtain an additional item of information about the user based upon the numeric data; and apply a business rule to determine a characteristic of a wireless service plan for the user, wherein the business rule is based upon information about the user.

23. The apparatus of claim 22, wherein the numeric information about the user is a social security number.

24. The apparatus of claim 22, wherein the numeric information about the user is a telephone number of the user.

25. The apparatus of claim 22, wherein the additional item of information is obtained by formulating a query based on the numeric data about the user, sending the query to a demographic database, and receiving a response from the demographic database.

26. The apparatus of claim 22, wherein the additional item of information is obtained by formulating a query based on the numeric data about the user, sending a query to a credit bureau database, and receiving in response a credit score for the user.

27. The apparatus of claim 22, wherein the activation instructions are further adapted to send to the user a query to confirm the additional item of information and if the user correctly confirms the additional item of information, then to validate the user, and if the user does not correctly confirm the additional item of information, then not to validate the user.

28. The apparatus of claim 22, wherein the business rule requires that the user have a minimum credit score to activate a wireless service account for the user.

29. The apparatus of claim 22, wherein the business rule selects at least one rate plan based upon the credit score of the user.

30. An apparatus for activating a wireless service account for a user wherein the only information received from the user about the user is numeric.

31. A medium storing instructions adapted to be executed by a processor to perform actions including:
receiving from the user data about the user that is only numeric;
obtaining an additional item of information about the user based upon the numeric data; and
applying a business rule to determine a characteristic of a wireless service plan for the user, wherein the business rule is based upon information about the user.

32. The medium of claim 31, wherein the additional item of information is obtained by formulating a query based on the numeric data about the user, sending the query to a demographic database, and receiving a response from the demographic database.

33. The medium of claim 31, wherein the additional item of information is obtained by formulating a query based on the numeric data about the user, sending a query to a credit bureau database, and receiving in response a credit score for the user.

34. The medium of claim 31, wherein said instructions are further adapted to perform actions including:
sending to the user a query to confirm the additional item of information;
if the user correctly confirms the additional item of information, then the user is validated; and
if the user does not correctly confirm the additional item of information, then the user is not validated.

35. The medium of claim 31, wherein the business rule requires that the user have a minimum credit score to activate a wireless service account for the user.

36. A system for activating a wireless service account for a user, including:
means for entering numerical user information;
means for obtaining an additional item of information about the user based upon the numerical user information; and
means for applying a business rule to determine a characteristic of a wireless service plan for the user, wherein the business rule is based upon information about the user.

37. A method for activating a wireless services account for a user, including:
sending information about the user that is numerical only to an activation server that obtains an additional item of information about the user based upon the numeric data, and applies a business rule to determine a characteristic of a wireless service plan for the user.
